(19) United States
(12) Patent Application Publication
(10) Pub. No.: US 2005/0178054 A1
(43) Pub. Date: Aug. 18, 2005

(54) Stacking autoclaveable mushroom culture jar with filter lid

(76) Inventor: Wei K. Hsu, Garland, TX (US)

Correspondence Address: SHERMAN D PERNIA, ESQ., PC, 1110 NASA ROAD ONE, SUITE 450, HOUSTON, TX, 77058-3310, US

(21) Appl. No.: 11/008,076

(22) Filed: Dec. 9, 2004

Related U.S. Application Data
(60) Provisional application No. 60/528,279, filed on Dec. 9, 2003.

(51) Int. Cl. A01G 1/04

(52) U.S. Cl. 47/1.1

(57) ABSTRACT

The present invention is a vertically stacking, autoclaveable culture jar suitable for use in the mushroom growing field. The present culture jar has a vessel member or container portion having an opening in its top end that is substantially as large as the cross-section of the container portion. The jar is closed using a stacking filter lid. The filter lid has an upper section configured to receive the bottom end of another vessel member, and a lower section configured as a screw-cap to engage and seal the top end of the container vessel. A filter section disposed between the upper and lower sections of the filter cap, and includes a filter housing and a ventilation chamber. The filter housing holds a filter element, and the interior space vents the enclosed volume of the vessel member to atmosphere through the filter element.

### FIELD OF THE INVENTION

The present invention is in the field of sterilizable cultivation containers for growing selected organisms in isolation from the ambient environment. More specifically, the present invention relates to a microfiltration membrane cap and culture jar combination that is sterilizable and useful for the cultivation of edible fungi.

### BACKGROUND OF THE INVENTION

Culture bottles or flasks are used for the culturing of cells and tissue and are known in the field. These devices are structurally quite simple, generally consisting of a main body with a neck, a neck port and cap. See U.S. Pat. No. 5,139,952 (Honda et al.) and U.S. Pat. No. 6,818,438 (Muser). Although the culture bottles disclosed in these references may be useful for their intended purposes, they provide a less than satisfactory solution for certain culturing needs in the mushroom growing field, such as a large opening for the introduction of solid growth media to the vessel. Further, in the mushroom growing field it is useful to have easily interchangeable caps with a microfilter membrane that allows for a sterile aerobic environment inside the vessel.

### SUMMARY OF THE INVENTION

An object of the present invention is to provide a combination culture jar and microfilter cap having the utility of certain typical prior culture bottles, but without certain of their disadvantages. More specifically, The culture jar is intended to allow for having a filter cap that can be used with a variety of filter membrane types. The transportability of the combination culture jar and cap is accomplished at least in part by an integral stacking feature that enables the bottom of one jar to interface with the top of another.

The present invention is a vertically stacking culture jar useful in the mushroom growing field for containing a growth media in a clean/sterile aerobic environment. That is, the contained environment is in gas exchange with ambient atmosphere. Additionally, the present culture jar is made of material resistant to the heat and conditions of a sterilizing means such as a steam autoclave. The culture jar has two main components: a vessel member and a stacking filter lid. In a preferred embodiment, these components were made of polycarbonate plastic, which had the feature of being clear as well as being autoclaveable. Depending on a user's preference, either the stacking lid, the vessel member or both can be made to be clear. Other plastic materials suitable for practicing the present invention are known to and selectable by the ordinary skilled artisan.

The top end opening of the present culture jar is in a plane perpendicular to the height of the vessel member. The top end opening is jar-like in that it is intended in the present invention to approach in size the cross-section of the vessel member. In a preferred embodiments shown in the figures, the present culture jar had a top end opening with approximately the same cross-section as the vessel member. Of course, the bottom end of the vessel member is closed, and the enclosed volume of the vessel member is disposed to contain a culture medium.

The stacking filter lid has three sections to it: an upper section, a lower section and a middle filter housing section. The upper section is configured to receive the bottom end of another vessel member. The lower section is configured as ajar lid to engage and seal the open top end of the vessel member. The filter is section disposed between the upper and lower sections of the filter cap. When the filter lid is in place closing the top end opening of the vessel member, the bottom end of the vessel member of a second culture jar can be inserted into the upper section of the filter lid. In this manner, the autoclaveable culture jars of the present invention can form a secure vertical stack.

The lower section of the filter lid differ from typical jar lids in its combination with the filter housing a, but an appropriate closure means for practice in the lid may be selected from those typical in the field. In the preferred embodiment of the figures, the lower section of the filter lid was configured as a threaded screw cap and engaged complementary threads on the top end of the vessel member as a closing/sealing means. However, other closing or sealing means are know to and selectable by one of ordinary skill in the art for practice in the present invention: for example, a snap cap or a Tupper Ware™ type seal.

The upper section of the stacking filter lid serves as a holder for receiving the bottom end of another culture jar's vessel member. How securely the upper section receiver holds the other vessel member is selectable by the ordinary skilled artisan. In the preferred embodiment illustrated, the filter lid receiver positively engaged the bottom of the other vessel member either with interlocking features or with a frictional grip. Other positive and less positive stacking means are known and available in the art for practice in the present invention.

The filter section of the stacking lid including a filter housing and a ventilation chamber. In one of the preferred embodiments illustrated, the filter housing had an interior space for receiving and containing a filter material, such as a filter fiber (e.g., cotton batting). In another embodiment, the filter housing mounted a sterilizing micro-filtration membrane.

Additionally, the filter section of the stacking lid included a vent chamber. The vent chamber's function was served when a second vessel member is disposed in the lid's upper section. In this situation, the vent chamber on the lid allowed the interior volume of the capped vessel member to vent to atmosphere through the filter housing and vent chamber. This is an important feature of stacking aerobic culture jars, otherwise sufficient gas exchange may not occur in lower jars when stacked, and adversely effect physiological parameters (e.g., pH) in the culture environment.

### BRIEF DESCRIPTION OF THE DRAWINGS

FIG. 1 is a partial cross-sectional side view of a vessel member of the present invention for use with the filter lids of FIGS. 2A and 2B.

FIGS. 2A and 2B are cross-sectional side views of the filter lids of a preferred embodiment of the present autoclaveable mushroom culture jar. One filter lid (B) is optionally for use with culture jar at the top of a stack of present culture jars.

FIG. 3 is a schematic representation of a cross-sectional view of a stackable embodiment of the present culture jar, showing the bottom of one culture jar receiving the top of another culture jar.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

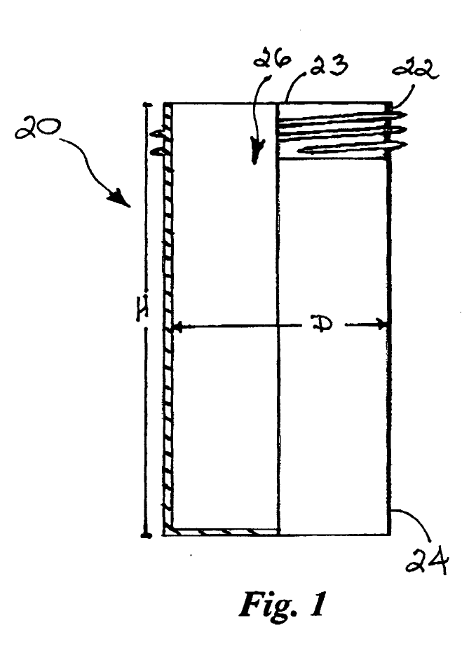

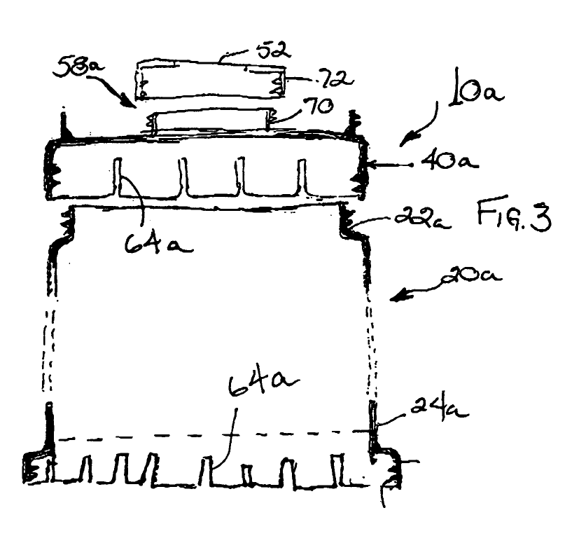

As illustrated in the figures, the present invention is a vertically stacking culture jar with an air filtering lid. The present culture jar 10 comprises two separate main components: a vessel member 20 and a filter lid 40. As illustrated in FIG. 1, the vessel member 20 has an opening 23 at its top end 22, a closed bottom end 24 and an enclosed volume or interior space 26 disposed to contain a culture medium. It is intended that the vessel member stand upright on its bottom end, and that the opening 23 at the top end 22 is in a plane perpendicular to the height H of the vessel member 20. In the preferred embodiments illustrated, the top end opening 23 was approximately the same internal diameter D as the cross-section as the vessel member 20. The dimensions of the vessel member 20 can vary widely. The vessel member 20 of FIG. 1 had a height H of 10 cm and an diameter D of 2.5 cm. The vessel member 20a of FIGS. 3 and 4 had a height H of about 6 inches and a diameter D of about 4.5 inches.

In the embodiment shown in FIGS. 3 and 4, the vessel member 20a of the present culture jar 10 has the additional feature at its bottom end of a positive engagement means 34 for interfacing with a complementary means 32 on the upper section 24 of a filter lid 40 to provide a secure stacking mechanism. In the figure, the engagement means 32 and 34 are complementary screw threads. However, other know engagements means are adaptable by the ordinary skilled artisan for practice in the present invention. For example, complementary detent rings could be provided instead of complementary threads. In this fashion, a plurality of culture jars 10 can be more securely stacked on top of each other.

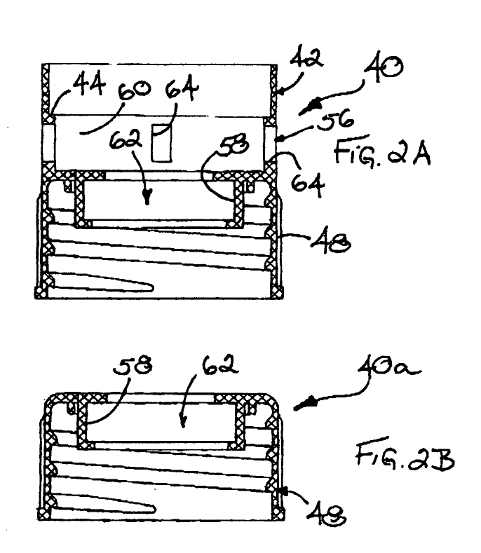

As illustrated in FIG. 2A, the stacking filter lid 40 has an upper section 42, a lower section 48 and a middle filter section 56. The upper section 42 is configured to receive the bottom end 24 of another vessel member 20. The upper or receiver section 42 includes a seat or stop 44 that prevents the bottom end 24 of another vessel member 20 from being advanced so far into the filter lid as to occlude gas communication between the filter section 56 and atmosphere. The lower section 48 is configured as ajar lid to engage and seal the opening 23 at the top end 22 of the vessel member 20.

The filter section 56 is disposed between the upper 42 and lower 48 sections of the filter lid 40. The filter section 56 includes a filter housing 58 and a ventilation chamber 60. The filter housing has an interior space 62 for receiving and retaining a filter material (not shown). The interior space 62 is in gas communication with the ventilation chamber 60 and the enclosed volume 26 of the vessel member 20. The ventilation chamber 60 has a number of vent ports 64 through it which allow ready gas exchange between the interior space 62 of the filter housing 58 and atmosphere when the bottom end 24 of the other vessel member 20 is received in the upper section 42 of the filter lid 40.

As a part of a vertically stacking culture jar system, the present invention includes an optional non-stacking filter lid 80 as illustrated in FIG. 2B. The optional non-stacking filter lid 80 is also configured as a jar lid to engage and seal the top end opening 28 of the vessel member 20. The non-stacking filter lid 80 includes a filter housing having an interior space for receiving and retaining a filter material, but doe not have an upper receiver section.

The filter lid 40 contains a particulate filtering means which could be as simple as a paper or fiber filter in the case of filtering out relatively large particles, or can be a micropore filter membrane 52 (see FIG. 3). FIG. 3 shows the threaded lid 40a of one jar as it fits into the stacking feature of another jar. Additionally, FIG. 3 illustrates a filter housing 58a configured in two parts: a housing fitting 70 with a screw cap 72. A filter membrane 52 is mounted on the screw cap 72, and can be used to fit the culture jar 10a with replaceable filters. In practicing the present stackable culture jar 10, filter lid 40 and the vessel member 20 were made of a plastic material that could withstand sterilizing temperatures of 260 degrees F. or higher. In fact, in the preferred embodiment illustrated, the lids 40 & 40a and the vessel members 20 & 20a were made of polycarbonate which has the characteristic of being heat resistant. Additionally, polycarbonate resists breakage and is transparent, allowing the contents of the jar to be viewed. Also, typical maker pens can be used to label the jars directly on their surfaces.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

1. A vertically stacking culture jar comprising:
a vessel member having a open top end and a closed bottom end and an enclosed volume disposed to contain a culture medium;
a stacking filter cap having an upper section configured to receive the bottom end of another vessel member, and having a lower section configured as a jar lid to engage and seal the open top end of the vessel member, and a filter section disposed between the upper and lower sections of the filter cap, the filter section including a filter housing and a ventilation chamber, the filter housing having an interior space for receiving and retaining a filter material, the interior space in gas communication with the filter cap ventilation chamber and the enclosed volume of the vessel member, and the ventilation chamber having vents ports allowing ready gas exchange between the interior space of the filter housing and atmosphere when the bottom end of the other vessel member is received in the upper section of the filter cap; and
the vessel member and the filter cap constructed of an autoclaveable plastic material.

2. The vertically stacking culture jar of claim 1, wherein the autoclaveable plastic material is clear.

3. The vertically stacking culture jar of claim 1, wherein the autoclaveable plastic material comprises a polycarbonate plastic material.

4. A vertically stacking culture jar system comprising:
the vertically stacking culture jar of claim 1; and
a second, non-stacking filter cap configured as ajar lid to engage and seal the open top end of the vessel member, and including a filter housing having an interior space for receiving and retaining a filter material, the interior space in gas communication with atmosphere and the enclosed volume of the vessel member, and allowing ready gas exchange between the interior space of the filter housing and atmosphere.
